(19) United States
(12) Patent Application Publication
(10) Pub. No.: US 2026/0174531 A1
(43) Pub. Date: Jun. 25, 2026

(54) DENTAL PROSTHESIS INCLUDING A DENTAL FRAMEWORK, DENTAL FRAMEWORK, AND METHOD TO MANUFACTURE A DENTAL PROSTHESIS

(71) Applicant: PANTHERA DENTAL INC., Quebec (CA)

(72) Inventors: Gabriel Robichaud, Quebec (CA); Remi Vaillancourt, Quebec (CA); Beatrice Robichaud, Quebec (CA); Jean Robichaud, Quebec (CA)

(21) Appl. No.: 18/726,778

(22) PCT Filed: Dec. 28, 2022
(86) PCT No.: PCT/CA2022/051902

§ 371 Date: Jul. 3, 2024

(51) Int. Cl. A61C 13/00; A61C 13/08

(52) U.S. Cl. CPC A61C 13/0004; A61C 13/08

(57) ABSTRACT

There is provided a dental framework comprising a base and a 3D lattice network protruding from the base. There is also provided a dental prosthesis comprising: a prosthesis body with a mucosal tissue-contacting surface and an outer surface, the prosthesis body includes the dental framework and a denture mucosal tissue body mounted to the dental framework and filing void of the 3D lattice network. There is also provided processes for manufacturing a dental prosthesis and a dental framework.

### CROSS-REFERENCE TO RELATED APPLICATIONS

This application claims priority under 35 USC § 119(e) of U.S. provisional patent application 63/266,439 filed on Jan. 5, 2022, the specification of which is hereby incorporated by reference.

### TECHNICAL FIELD OF THE INVENTION

The present invention relates to a dental prosthesis including a dental framework, a dental framework for a dental prosthesis and to a method to manufacture a dental prosthesis.

### BACKGROUND

Patients are always looking for aesthetic, comfortable and durable dental prostheses. Implant-retained dental prostheses (or overdentures) can be connected to various attachments (or frameworks) including bar attachments, which distribute the stress between the implants and provide suitable retention. Attachment bars characterized by the metal lingual concept, such as the Montreal bar design, reduce the thickness of the prosthesis more than an acrylic lingual model and, thereby increases the patient's comfort.

However, reduced acrylic resin thickness over a metal substructure, such as an attachment bar, can cause failures. There is a need for dental prostheses wherein the adhesion between acrylic (or other mucosal tissue mimicking material) and the prosthesis framework, such as a metal substructure, is increased while maintain the reduced thickness of the prosthesis and which can be cost-effectively manufactured. It is therefore an aim of the present invention to address the above-mentioned issues.

### BRIEF SUMMARY OF THE INVENTION

It is therefore an aim of the present invention to address the above-mentioned issues.

According to a general aspect, there is provided a dental prosthesis comprising: a prosthesis body with a mucosal tissue-contacting surface and an outer surface, the prosthesis body comprising: a dental framework comprising a base and a 3D lattice network protruding from the base; and a denture mucosal tissue body mounted to the dental framework and filing void of the 3D lattice network.

In some embodiments, the dental prosthesis further comprises denture teeth mounted to the prosthesis body and having an exposed portion protruding from the outer surface of the prosthesis body.

In some embodiments, the dental framework further comprises support posts engageable with anchors protruding from a mucosal tissue of a patient's jaw.

In some embodiments, each one of the support posts comprises an anchor connector extending from the base of the dental framework and on a side opposed to the 3D lattice network.

In some embodiments, the anchor connector comprises a tubular body.

In some embodiments, the tubular body is substantially circular in cross-section.

In some embodiments, the anchors comprise implants.

In some embodiments, the dental framework is made of a material selected from the group consisting of titanium, cobalt, chrome, zirconia, silver, palladium, nickel, and plastic.

In some embodiments, the dental framework is made by additive manufacturing.

In some embodiments, the dental framework is made by laser sintering.

In some embodiments, the 3D lattice network comprises a crisscross pattern of strips wherein at least 80% of volume is void.

In some embodiments, a diameter of the strips of the 3D lattice network is ranging between 0.1 mm and 0.3 mm.

In some embodiments, the diameter of the strips of the 3D lattice network is ranging between 0.15 mm and 0.25 mm.

In some embodiments, the denture mucosal tissue body is made of acrylic resin.

In some embodiments, the 3D lattice network is integral with the base.

In some embodiments, the 3D lattice network is entirely contained in the denture mucosal tissue body.

In some embodiments, a layer of the denture mucosal tissue body covers the 3D lattice network, and the layer has a thickness sufficient to receive a portion of denture teeth therein.

In some embodiments, the mucosal tissue-contacting surface of the prosthesis body comprises a surface of the base exposed outwardly.

In some embodiments, the base is substantially U-shaped in profile.

In some embodiments, a surface of the base from which the 3D lattice network protrudes is concave.

In some embodiments, the 3D lattice network extends outwardly of a U-shaped cavity defined by the concave surface of the base.

According to another general aspect, there is provided a dental framework for a dental prosthesis comprising: a dental framework comprising a base and a 3D lattice network protruding from the base.

In some embodiments, the dental framework further comprises support posts engageable with anchors protruding from a mucosal tissue of a patient's jaw.

In some embodiments, each one of the support posts comprises an anchor connector extending from the base and on a side opposed to the 3D lattice network.

In some embodiments, the anchor connector comprises a tubular body.

In some embodiments, the tubular body is substantially circular in cross-section.

In some embodiments, the dental framework is made of a material selected from the group consisting of titanium, cobalt, chrome, zirconia, silver, palladium, nickel, and plastic.

In some embodiments, the dental framework is made by additive manufacturing.

In some embodiments, the dental framework is made by laser sintering.

In some embodiments, the 3D lattice network comprises a crisscross pattern of strips wherein at least 80% of volume is void.

In some embodiments, the 3D lattice network is integral with the base.

In some embodiments, the base is substantially U-shaped in profile.

In some embodiments, a surface of the base from which the 3D lattice network protrudes is concave.

In some embodiments, the 3D lattice network extends outwardly of a U-shaped cavity defined by the concave surface of the base.

According to still another general aspect, there is provided a process for manufacturing a dental prosthesis comprising: obtaining a 3D digital model of the dental framework including a base and a 3D lattice network protruding from the base; and additive manufacturing the dental framework using the 3D digital model.

In some embodiments, the dental framework further comprises support posts.

In some embodiments, the dental framework is manufactured by additive manufacturing on a support plate.

In some embodiments, the additive manufacturing of the dental framework comprises laser sintering the dental framework on the support plate.

In some embodiments, the process further comprises generating a 3D digital model of a patient's jaw including soft tissue contours and anchor positions and designing the 3D digital model of the dental framework using the 3D digital model of the patient's jaw.

In some embodiments, generating the 3D digital model of the patient's jaw comprises scanning a positive physical cast of a jaw impression.

According to yet another general aspect, there is provided a process for manufacturing a dental prosthesis comprising: manufacturing a dental framework by additive manufacturing, the dental framework comprising a base and a 3D lattice network protruding from the base; inserting the dental framework in an injection mold; injecting a denture mucosal tissue material in the injection mold to embed the 3D lattice network of the dental framework at least partially in the denture mucosal tissue material; and machining an assembly including the dental framework at least partially covered by the denture mucosal tissue material to obtain the dental prosthesis including the dental framework at least partially embedded in a denture mucosal tissue body.

In some embodiments, the process further comprises generating a 3D digital model of the dental prosthesis including a 3D digital model of a dental framework of the dental prosthesis and wherein the manufacturing of the dental framework is carried out using the 3D digital model.

In some embodiments, machining the dental framework is carried out using the 3D digital model.

In some embodiments, the 3D digital model of the dental prosthesis comprises denture teeth positions.

In some embodiments, the process further comprises generating a 3D digital model of a patient's jaw including soft tissue contours and anchor positions and designing the 3D digital model of the dental framework using the 3D digital model of the patient's jaw.

In some embodiments, machining the denture mucosal tissue material comprises shaping an impression surface of the dental prosthesis to have at least a portion thereof being complementary is shape to the soft tissue contours of the patient's jaw.

In some embodiments, the dental framework further comprises support posts and machining the assembly comprises machining the denture mucosal tissue material to expose at least partially the support posts on an impression surface of the dental prosthesis.

In some embodiments, the dental framework is manufactured by additive manufacturing on a support plate.

In some embodiments, the dental framework mounted to the support plate is inserted in the injection mold.

In some embodiments, machining the assembly comprises separating the dental framework from the support plate.

In some embodiments, injecting the denture mucosal tissue material in the injection mold forms a denture mucosal tissue material block in which the dental framework is embedded.

In some embodiments, the additive manufacturing of the dental framework comprises laser sintering the dental framework on the support plate.

In some embodiments, the process further comprises mounting denture teeth to the denture mucosal tissue body of the dental prosthesis.

According to yet another general aspect, there is provided a process for manufacturing a dental prosthesis comprising manufacturing a dental framework by additive manufacturing on a support plate; inserting the dental framework mounted to the support plate in an injection mold; injecting a denture mucosal tissue material in the injection mold to embed the dental framework at least partially in the denture mucosal tissue material and form a denture mucosal tissue material block including the dental framework mounted to the support plate; and machining the denture mucosal tissue material block to obtain the dental prosthesis including the dental framework at least partially embedded in a denture mucosal tissue body.

In some embodiments, the dental framework comprises a base and a 3D lattice network protruding from the base.

In some embodiments, the denture mucosal tissue material block comprises the 3D lattice network of the dental framework embedded at least partially into the denture mucosal tissue material.

In some embodiments, the process further comprises generating a 3D digital model of the dental prosthesis including a 3D digital model of a dental framework of the dental prosthesis and wherein the manufacturing of the dental framework is carried out using the 3D digital model.

In some embodiments, machining the dental framework is carried out using the 3D digital model.

In some embodiments, the 3D digital model of the dental prosthesis comprises denture teeth positions.

In some embodiments, the process further comprises generating a 3D digital model of a patient's jaw including soft tissue contours and anchor positions and designing the 3D digital model of the dental framework using the 3D digital model of the patient's jaw.

In some embodiments, machining the denture mucosal tissue material comprises shaping an impression surface of the dental prosthesis to have at least a portion thereof being complementary is shape to the soft tissue contours of the patient's jaw.

In some embodiments, the dental framework further comprises support posts and machining the denture mucosal tissue material block comprises machining the denture mucosal tissue material to expose at least partially the support posts on an impression surface of the dental prosthesis.

In some embodiments, machining the denture mucosal tissue material block comprises separating the dental framework from the support plate.

In some embodiments, the additive manufacturing of the dental framework comprises laser sintering the dental framework on the support plate.

In some embodiments, the process further comprises mounting denture teeth to the denture mucosal tissue body of the dental prosthesis.

According to yet another general aspect, there is provided a process for manufacturing a dental prosthesis comprising: obtaining 3D imaging data of a patient's jaw including soft tissue contours and anchor positions; obtaining 3D imaging data of a dental prosthesis model including denture teeth positions; generating a 3D digital model of the dental prosthesis including a 3D digital model of a dental framework of the dental prosthesis; manufacturing the dental framework on a support plate using the 3D digital model of the dental framework; inserting the dental framework mounted to the support plate in an injection mold; injecting a denture mucosal tissue material in the injection mold to at least partially embed the dental framework in the denture mucosal tissue material and form a denture mucosal tissue material block; and machining the denture mucosal tissue material block using the 3D digital model of the dental prosthesis to obtain the dental prosthesis including the dental framework at least partially embedded in a denture mucosal tissue body.

In some embodiments, obtaining imaging data of the patient's jaw comprises scanning a positive physical cast of a jaw impression.

In some embodiments, obtaining imaging data of the dental prosthesis model including the denture teeth positions comprises scanning a diagnostic wax up.

In some embodiments, scanning the diagnostic wax up comprises scanning the diagnostic wax up without denture teeth.

In some embodiments, the dental framework of the dental prosthesis comprises a base and a 3D lattice network protruding from the base.

In some embodiments, manufacturing the dental framework on the support plate comprises additive manufacturing the dental framework.

In some embodiments, the additive manufacturing of the dental framework comprises laser sintering the dental framework on the support plate.

In some embodiments, machining the denture mucosal tissue material block comprises separating the dental framework from the support plate.

In some embodiments, the process further comprises mounting denture teeth to the denture mucosal tissue body of the dental prosthesis.

In some embodiments, the dental framework further comprises support posts and machining the denture mucosal tissue material block comprises machining the denture mucosal tissue material to expose at least partially the support posts on an impression surface of the dental prosthesis.

In some embodiments, machining the denture mucosal tissue material comprises shaping an impression surface of the dental prosthesis to have at least a portion thereof being complementary is shape to the soft tissue contours of the patient's jaw.

### BRIEF DESCRIPTION OF THE DRAWINGS

FIG. 1 is a schematic front perspective view of a dental prosthesis including a denture mucosal-tissue body and denture teeth in accordance with an embodiment, wherein the dental prosthesis is mounted to a jaw model;

FIG. 2 is a cross-sectional view of the dental prosthesis of FIG. 1, showing the denture mucosal-tissue body mounted to a dental framework, implants securing the dental framework to the jaw model, and denture teeth in accordance with an embodiment;

FIG. 3 is a cross-sectional view, enlarged, of dental prosthesis of FIG. 1;

FIG. 4 is a perspective view of a dental framework in the shape of an attachment bar for a dental prosthesis in accordance with an embodiment;

FIG. 5 is a perspective view, enlarged, of a portion of the dental framework of FIG. 4 showing a 3D lattice network in accordance with an embodiment;

FIG. 6 is a front perspective view of the dental prosthesis of FIG. 1, partially sectioned, showing the denture mucosal-tissue body with denture teeth mounted to the dental framework, the denture mucosal-tissue body with denture teeth being cross-sectioned to show the dental framework secured to the jaw model of a patient;

FIG. 7 is a perspective view, enlarged, of the cross-section portion of FIG. 6;

FIG. 8 is a first flowchart of a manufacturing process for a dental prosthesis in accordance with an embodiment using a 3D imaging of a patient's jaw;

FIG. 9 is a second flowchart of a manufacturing process for a dental prosthesis in accordance with another embodiment using a 3D imaging of a positive physical cast of a patient's jaw;

FIG. 10 is a perspective view of the dental framework of FIG. 4 manufactured on a support plate in accordance with an embodiment;

FIG. 11 is a perspective view, enlarged, of a portion of the dental framework of FIG. 10 showing the 3D lattice network of the dental framework; and

FIG. 12 is a schematic cross-section view of an injection mold containing a dental framework printed on a support plate.

It will be noted that throughout the appended drawings, like features are identified by like reference numerals.

### DETAILED DESCRIPTION

Moreover, although the embodiments of the dental prosthesis including its dental framework and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the dental prosthesis including its dental framework, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, it will be appreciated that positional descriptions such as “above”, “below”, “forward”, “rearward” “left”, “right” and the like should, unless otherwise indicated, be taken in the context of the figures and correspond to the position and orientation of the dental prosthesis including its dental framework and corresponding parts when being worn by a patient, with the “front”/“anterior” corresponding to a position closer to the incisors of the patient and the “back”/“rear”/“posterior” corresponding to a position closer to the molars of the patient. Positional descriptions should not be considered limiting.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value. In the following description, the term “about” means within an acceptable error range for the particular value as determined by one of ordinary skill in the art, which will depend in part on how the value is measured or determined, i.e., the limitations of the measurement system. It is commonly accepted that a 10% precision measure is acceptable and encompasses the term “about”.

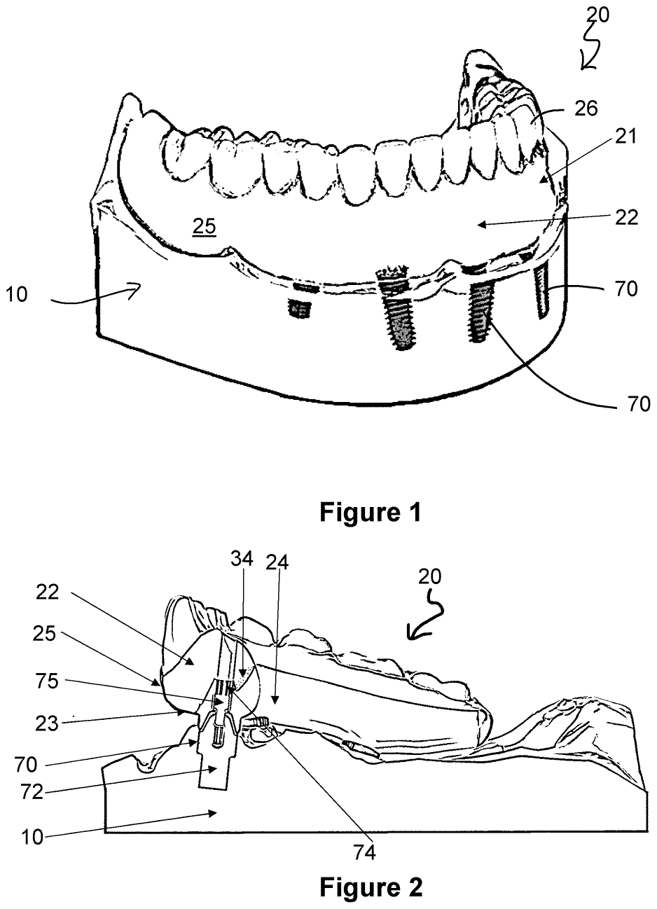

Referring to FIG. 1, there is shown a dental prosthesis 20 including a prosthesis body 21 with a mucosal tissue-contacting surface (or impression surface) 23 (FIG. 2) and an outer surface 25, which includes the occlusal surface and the polished surface, and denture teeth 26. The impression surface refers to the surface that is formed via the impression and/or is in contact with the tissue. The occlusal surface is the surface where the artificial teeth are arranged, and the polished surface is the surface not comprised of the aforementioned two surfaces.

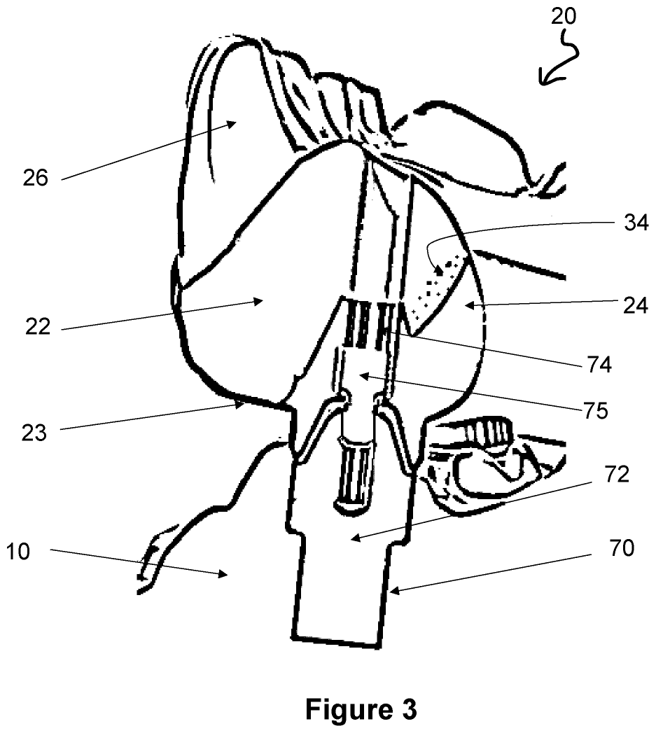

The prosthesis body 21 includes a denture mucosal tissue (or gum-material) body 22 and a dental framework 24 (FIG. 2), the denture mucosal tissue body 22 being mounted to the dental framework 24 or the dental framework 24 being at least partially embedded in the denture mucosal tissue body 22. In the illustrated embodiment of FIGS. 1 to 8, the dental prosthesis 20 is a complete prosthesis to be implanted in a patient's mouth with all of the original teeth of the patient missing, but it is understood that the dental prosthesis may also be embodied as a partial prosthesis, where only some of the patient existing teeth are missing. The dental prosthesis 20 can be implanted on a maxillary jaw or a mandibular jaw of the patient, or both. In some embodiment, the dental prosthesis 20 can be removable, i.e., the dental prosthesis 20 can be removed from the mouth of the patient for daily maintenance or simply to sleep.

The denture teeth 26 are mounted to the prosthesis body 21 and have an embedded portion located in the denture mucosal tissue body 22 and an exposed portion protruding from the occlusal surface of the prosthesis body 21. In an embodiment, a layer of the denture mucosal tissue body covering the 3D lattice network has a thickness sufficient to receive a portion of denture teeth therein. The denture teeth 26 can be made of any appropriate dental material including but without being limited to composite resin, acrylic resin, lithium disilicate, zirconia, polyetherketoneketone (PEKK), feldspathic ceramic, aluminum ceramic, etc.

In a non-limitative embodiment, as shown in FIGS. 1 to 3, the dental prosthesis 20 will be attached to anchors 70, such as implants, which in turn are secured in the patient's mouth. In FIGS. 1 to 3, the anchors are secured to a jaw model for the purpose of illustration. More particularly, the patient's jaw 10, either the mandible or the maxilla, is overlaid with soft mucosal tissue in the oral cavity, which may include but not limited to mucosal, gingiva, or alveolar tissue. The anchors 70 are secured to the patient's mandible or maxilla 10, retained within the jawbone by a screw thread or pressed fitted 72 into a hole formed with a drill, reamer, broach, osteotome, and the like. Therefore, the anchors 70 are permanently secured in the patient's jaw. A protruding portion 74 of each one of the anchors 70 is exposed above the mucosal tissue for coupling to and supporting the dental prosthesis 20. In some embodiment, the screw 75 (or any portion contained inside the jaw) and the protruding portion 74 can be separate elements, configured to be assembled together to form the anchor 70. It is appreciated that the number, the shape, and the configuration of the anchors 70 in the patient's mouth can vary from the implant shown. The anchors can be made of titanium or other biocompatible material with properties of tolerance by human body (specifically bones), strongness to support the prosthesis and longevity of the implant. The dental framework 24 functions as a structural support to the denture mucosal tissue body 22 and a point of attachment with the protruding portion 74 of the anchors 70, protruding from the patient's mucosal tissue, either from the maxillary jaw or the mandibular jaw. In a non-limitative embodiment, the denture mucosal tissue body 22 is made of a material mimicking the mucosal tissue such as gum and can be made of acrylic resin or composite resin. However, it is appreciated that other materials can be used. In some embodiments, the material used for the denture mucosal tissue body 22 can be tinted in a color nuance between pink and red to replicate the color of patient's mucosal tissue.

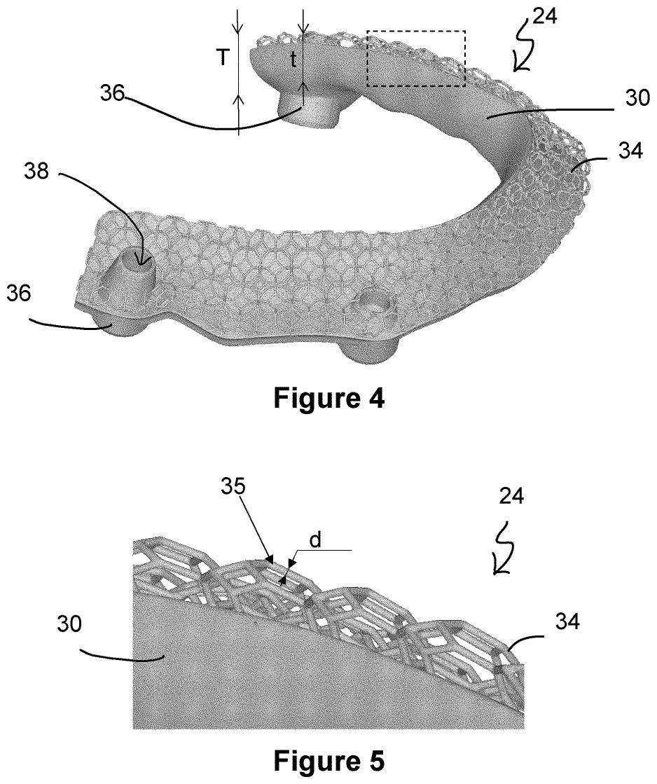

Turning now to FIGS. 4 and 5, there is shown a non-limitative embodiment of the dental framework 24 in the shape of an attachment bar (or dental bar). It comprises a base 30, a 3D lattice network 34 protruding from the base 30, and support posts 36 to connect the dental framework 24 to the dental implants (or anchors). In the embodiment of FIG. 4, the support posts 36 extend substantially vertically. However, in other embodiments, the support posts 36 can be angled and/or extend in different directions, based on the orientation of the anchors in the patient's mouth. In the non-limitative embodiment shown, each one of the support posts 36 has an internal cavity extending therethrough configured to receive or abut and secure a free end of the protruding portion 74 of one of the anchors 70. The geometrical shape of the internal cavity of the support posts 36 and the geometrical shape of the free end of the protruding portion 74 of the anchor 70 are substantially complementary for engagement and coupling therebetween. It is appreciated that, in an alternative embodiment (not shown), the dental framework 24 can be free of support posts.

In the embodiment shown, each one of the support posts 36 has a portion protruding outwardly from both surfaces of the base 30. A channel 38 extends therethrough and is designed to receive a mechanical fastener such as a screw, to secure the dental prosthesis 20 to the anchors 70. The portions of the support posts 36 protruding from the surface of the base 30 can be referred to as the anchor connectors, i.e., they will engage and/or abut with the anchors 70 protruding from the patient's jaw. In the embodiment shown, the anchor connectors are characterized by a tubular body, substantially circular in cross-section. However, it is appreciated that the shape of the support posts 36 can vary from the embodiment shown.

The dental framework 24 can be made of any appropriate dental material including but without being limited to dentistry suitable metals and alloys (such as and without being limitative titanium, cobalt, chrome, zirconia, silver, palladium, nickel, etc.), and plastic and it can be manufactured by additive manufacturing (or 3D printing) such as laser sintering.

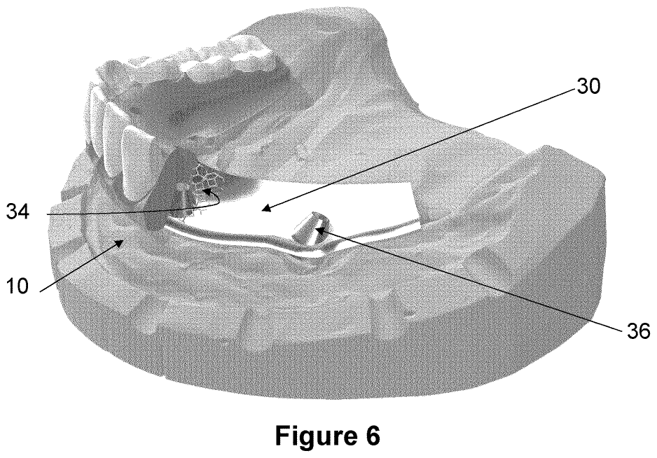

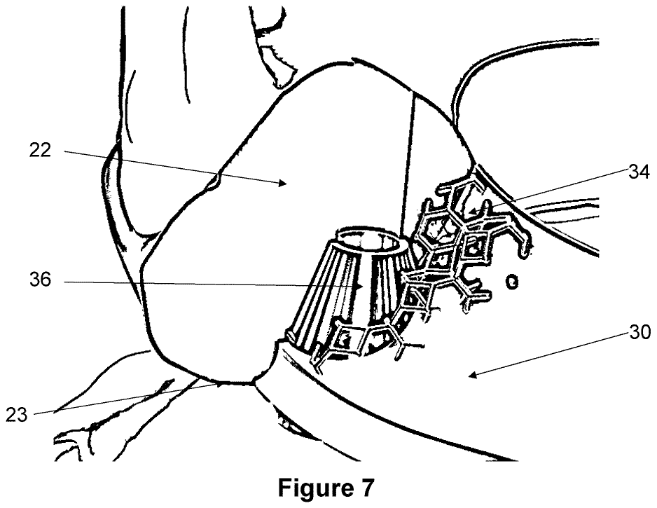

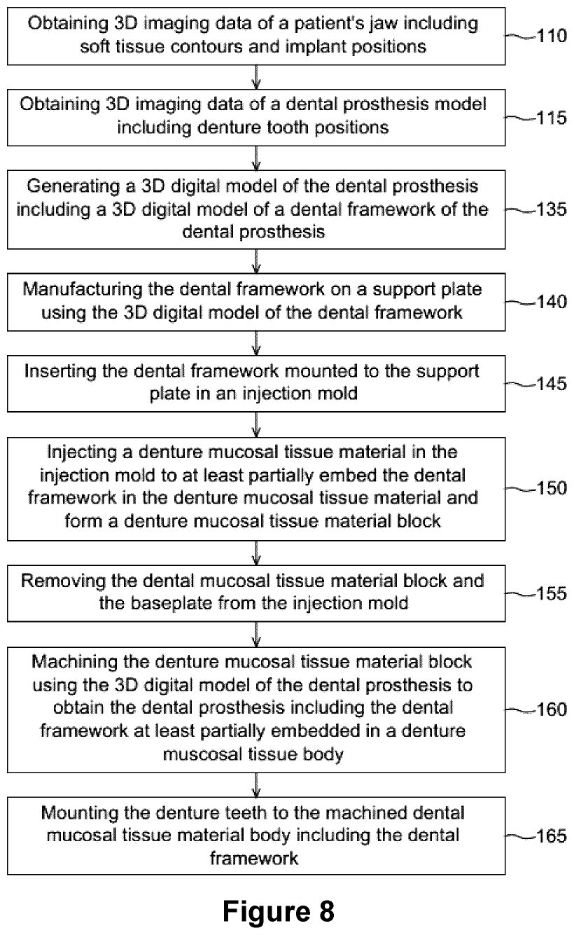

As shown in the non-limitative embodiment of FIGS. 6 and 7, the base 30 can be substantially U-shaped in profile. Furthermore, in the non-limitative embodiment shown, a surface of the base 30, from which the 3D lattice network 34 protrudes is concave. Therefore, the 3D lattice network 34 is at least partially contained inside a U-shaped cavity, defined by the concave surface, with a portion extending past the walls of the base 30 defining the concavity. The base 30 is designed to follow a predetermined shape along a tissue line of the patient's jaw, to ensure the dental framework 24 to perfectly fit on the patient's jaw and have a continuous contact with the tissues of the patient's jaw. It is appreciated that, in an alternative embodiment, all the surfaces of the base can be substantially planar.

The shape of the 3D lattice network 34 can vary from the embodiment shown but includes a crisscross pattern of strips 35 wherein at least 80% of volume of the crisscross pattern is void, as shown in FIGS. 4 and 5. In an embodiment, at least 90% of volume is void and, in another embodiment, at least 95% of volume is void. In an embodiment, the base 30 of the dental framework 24 has a thickness ranging between about 1.5 mm and 4.5 mm and, in another embodiment, the thickness of the base 30 is between about 2 mm and about 3.5 mm. The 3D lattice network 34 is characterized by a thickness t that can be shorter than a height of the base 30 of the dental framework 24. In a non-limitative embodiment, the thickness t of the 3D lattice network 34 is between about 0.75 mm to about 4.5 mm and, in another embodiment, the thickness t of the 3D lattice network 34 is between about 1 mm to about 2 mm and, in still another embodiment, the thickness t of the 3D lattice network 34 is between about 1.5 mm to about 2 mm. In a non-limitative embodiment, the thickness T of the dental framework 24, including the 3D lattice network 34 but excluding the support posts 36, is between about 2 mm to about 7 mm and, in another embodiment, the thickness T of the dental framework 24 is between about 3 mm to about 6 mm. In an embodiment, a ratio of the thickness t of the 3D lattice network 34 and the thickness T of the dental framework 24 ranges between about 10% to about 60% and, in another embodiment, this ratio ranges between about 15% and 50%. In an embodiment, the strips 35 of the 3D lattice network 34 are characterized by a mean diameter d ranging between about 0.1 mm and about 0.3 mm and, in another embodiment, between about 0.15 mm and about 0.25 mm.

In an embodiment, the additive manufacturing allows the 3D lattice network 34 and the base 30 of the dental framework 24 to be integral, i.e., they are manufactured as a single piece of material, therefore increasing strongness and longevity of the dental framework 24. In another embodiment, the 3D lattice network 34, base 30 and the support posts 36 are integral, i.e., manufactured as a single piece.

As shown in FIGS. 6 and 7, the denture mucosal tissue (or gum-material) body 22 fills most of the void of the 3D lattice network 34, i.e., the free space between the strips, and thereby improve the cohesion between the denture mucosal tissue body 22 and the dental framework 24. In an embodiment, the denture mucosal tissue body 22 entirely fills the void of the 3D lattice network 34, i.e., the 3D lattice network 34 is entirely contained in the denture mucosal tissue body 22 of the dental prosthesis 20. The dental framework 24 can be entirely embedded in the denture mucosal tissue body 22, e.g., for a denture gum-material lingual model (not shown), or part of the dental framework 24 can be exposed outwardly (as shown in FIGS. 2, 3, 6, and 7), e.g. for a metal lingual concept such as the Montreal bar design. In a metal lingual concept, the mucosal tissue-contacting surface 23 of the prosthesis body comprises a surface of the base 30, which is exposed, i.e., it is not covered by the denture mucosal tissue material, such as acrylic resin.

In FIGS. 2, 6, and 7, sections of the 3D lattice network 34 are shown embedded in the denture mucosal tissue body 22, adjacent to the base 30 of the dental framework 24.

It is appreciated that even if FIGS. 1 to 7 show the dental framework and the resulting dental prosthesis for a Montreal bar design, i.e., a metal lingual concept, the same concept can be applied to a wraparound concept wherein the entire dental framework is embedded in the denture mucosal tissue body. Similarly, the methods that will be described in the following paragraphs apply to both designs: the Montreal bar design and the wraparound design.

Furthermore, in FIGS. 1 to 3 and 7, the dental prosthesis 20 (or a portion thereof) is shown mounted to a jaw model instead of a real patient jaw and the anchors 70 are secured to the jaw model. However, it is appreciated that the anchors are configured to be inserted and secured to a patient's jaw, either the mandible or the maxillary, and engageable with the dental prosthesis 20.

Referring to FIG. 8, there is shown a flowchart of a non-limitative embodiment of a process to manufacture the dental prosthesis 20.

3D imaging data of a patient's jaw including soft tissue contours and anchor (implant) positions are obtained 110. 3D imaging data of the patient's jaw can be obtained by scanning the mouth of the patient with a tool including but without being limited to a cone-beam computed tomography (CBCT) equipment, an optical scanner, a contact scanner, or a combination thereof. In an embodiment, 3D imaging data of the patient's jaw can be obtained by scanning a positive physical cast of a jaw impression. A software can be used to turn captured images obtained from the scan into a digital 3D imaging data.

The imaging data also includes patient's existing teeth, if any. 3D imaging data of a dental prosthesis model including the denture teeth positions are also obtained 115. In an embodiment, the 3D imaging data of the dental prosthesis model can be obtained by scanning a diagnostic wax up of the dental prosthesis, as will be described in more details below. From these imaging data, a 3D digital model of the dental prosthesis including a 3D digital model of a dental framework of the dental prosthesis is created/generated 135. The 3D digital model of the dental prosthesis can be generated using a Computer Aided Design (CAD) software. The dental framework is manufactured on a support plate using the 3D digital model of the dental framework 140. In an embodiment, the dental framework is manufactured by additive manufacturing. The dental framework of the dental prosthesis can be manufactured using a Computer Aided Manufacturing (CAM) software, i.e., command of the additive manufacturing can be directly controlled by the CAM software. As mentioned above, the dental framework including the base, the 3D lattice framework, and the support posts, if any, can be manufactured as a single piece, i.e., the base, the 3D lattice framework, and the support posts are integral.

The dental framework mounted to the base plate is inserted in an injection mold 145 and a denture mucosal tissue material is injected in the injection mold to at least partially embed the dental framework in the denture mucosal tissue material and form a denture mucosal tissue material block 150. The denture mucosal tissue material fills the voids in the 3D lattice framework and at least partially cover same. In an embodiment, the 3D lattice framework is entirely contained (embedded) in the denture mucosal tissue material. The denture mucosal tissue material block and the support plate is removed 155 from the injection mold and is transferred to a machining unit wherein the denture mucosal tissue material block is separated from the support plate and machined using the 3D digital model of the dental prosthesis and a CAM software to obtain the dental prosthesis including the dental framework at least partially embedded in a denture mucosal tissue body 160.

Then, the denture teeth are bonded with ceramic glue for example to the machined dental prosthesis, including the dental framework 24, in the desired configuration/position/orientation 165 and, a final polishing step can be performed to finalize the dental prosthesis 20.

In further details, the dental prosthesis 20 is designed from a positive physical cast, such as a stone cast or a plaster model, of the dental impression and a diagnostic wax up created from an impression of the patient's mouth. The positive physical cast replicates the soft tissue contours and anchor positions in the patient's mouth. The diagnostic wax up represents the final prosthesis and ultimately the position of the denture teeth to be restored for the patient.

The positive physical cast can be created from a negative physical impression of the patient's mandible or maxilla, which can be made by using any suitable moldable material, such as an alginate, poly (vinyl siloxane), or the like, as it is known in the art of dentistry. The negative physical impression represents a negative of the patient's mandible or maxilla including the mucosal tissue, the patient's teeth (if any), and the position of the anchors protruding or recessed from the jaw.

Then, the positive physical impression (or cast) is created by pouring a suitable material into the cavity of the negative physical impression. For instance and without being limitative, a mixed dental stone material can be poured into the cavity of the negative physical impression, covering the surfaces of negative physical impression formed by the patient's mucosal tissues and teeth (if any) and submerging all of the analogs. Once filled into negative physical impression, the material is then permitted to harden, creating the positive physical impression, sometimes referred to as the stone cast.

Analogs, i.e., structures that replicate the anchors, such implants, are mounted to the positive physical impression. The analogs have the same spacing and orientation as the anchors, i.e., each analog is coaxial with and is disposed in the same position as a respective one of the anchors.

Thus, the positive physical impression positively replicates the position and orientation of the anchors while the portions of the positive physical impression surrounding the analogs positively replicates the surface of the mucosal tissues of the mouth and the patient's existing teeth, if any. Thus, the positive physical impression provides an accurate replica of the position and orientation of the anchors, the mucosal tissues, and the teeth (if any).

Once the dentist or the technician has created the positive physical impression, which is a positive replica of the patient's jaw, including replication of existing teeth (if any), mucosal tissue, and anchors (implants), the dentist then proceeds to the next step in the manufacturing process: designing and creating the dental prosthesis (or denture) that will be fitted to the patient's mouth (or the patient's jaw). A diagnostic wax-up is created to verify the proper location of the denture mucosal tissue and denture teeth with respect to the patient's actual mouth to ensure proper tooth orientation, and to ensure that the location and placement of the denture within the patient's mouth restores form, fit and function. Thus, the diagnostic wax-up is a model of and looks like the dental prosthesis that will be manufactured but is made of softer materials to permit it to be adjusted and adapted until the patient and dentist are pleased with its form, fit, function and aesthetics.

Thus, the dentist or the technician manually creates the diagnostic wax-up including the desired denture teeth position and occlusal orientation, using a flexible molding material. For instance and without being limitative, wax, acrylic, or other polymers can be used as flexible molding material. For the denture teeth, off-the-shelf denture teeth, which are commonly found in the market, can be selected.

In order to create the diagnostic wax up, the dentist or technician positions, upon the positive physical cast, (replacement or final) denture teeth as required for proper prosthetic function and aesthetics. As mentioned above, the denture teeth can be off-the-shelf denture teeth, i.e. commercially available and generally manufactured with predetermined geometries of a typical given tooth in various sizes by a third-party manufacturer. In some embodiment, the denture teeth can be custom made, based on client's or dentist's preference, with any appropriate dental material including but without being limited to composite resin, acrylic resin, lithium disilicate, zirconia, polyetherketoneketone (PEKK), feldspathic ceramic, aluminum ceramic, etc.

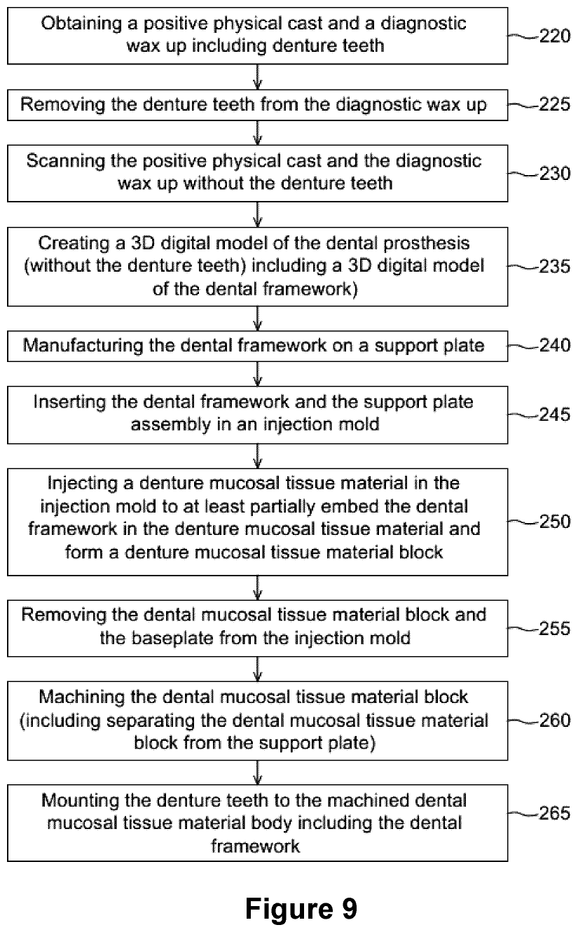

Referring now to FIG. 9, there is shown a flowchart of an alternate non-limitative embodiment of a process to manufacture the dental prosthesis 20, wherein the positive physical cast and the diagnostic wax up including the denture teeth are first obtained 220. For instance, the dentist can prepare and send to a suitable dental prosthesis manufacturing laboratory: (a) the positive physical cast replicating the soft tissue contours and the anchor positions in the patient's mouth and (b) a diagnostic wax up including the denture teeth mounted thereto in the predetermined configuration.

It is understood that the manufacturing process as described in FIGS. 8 and 9 only differs in the first steps, but the steps 135 to 165 are equivalent to the steps 235 to 265.

Then, using a silicon key, for instance, the denture teeth are removed from the diagnostic wax up 225 and reserved for future use.

Then, the positive physical cast including the anchor analog(s), i.e., the structure(s) that replicate(s) the anchor anchors (or attachments), and the diagnostic wax up, without the denture teeth, are scanned 230 to obtain 3D digital models of the positive physical cast and the desired dental prosthesis 235, without the denture teeth, respectively.

Using the 3D digital models of the positive physical cast and the desired dental prosthesis, without the denture teeth, a 3D digital model of the dental framework is created 235.

The dental framework 24 is manufactured 240 using the 3D digital model. As mentioned above, it can be manufactured by additive manufacturing (3D printing) such as laser sintering using any appropriate dental material including but without being limited to dentistry suitable metals and alloys (such as and without being limitative titanium, cobalt chrome, zirconia, silver, palladium, nickel, etc.), and plastic. It includes the base 30 with the 3D lattice network 34 protruding from the base 30 and the support posts 36 to connect and/or support the bar 24 to the dental implants (or anchors), if any. It is appreciated that the anchors in the patient's mouth may not be connected directly to the dental framework 24 and, more particularly, to the support posts 36. Abutments may be mounted on the anchors (i.e., the anchors (implants) have surmounted abutments) and the dental framework may be mounted to these abutments, and thus indirectly mounted to the anchors. If the dental framework being designed is intended to be mounted on abutments mounted to the anchors, the analogs of the positive physical cast can be provided with surmounted abutments.

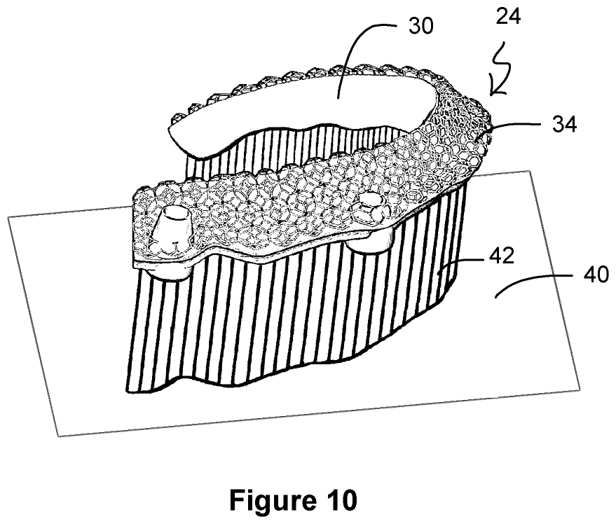

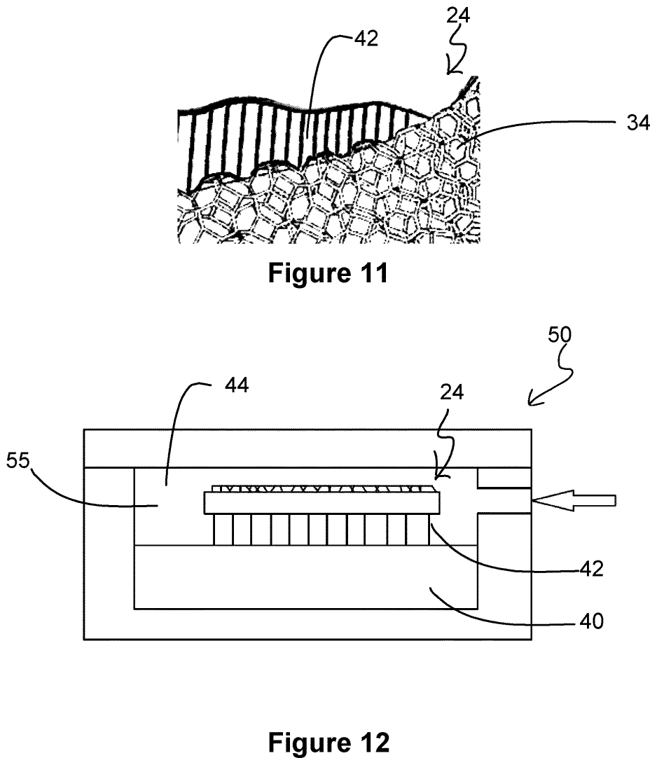

As shown in FIGS. 10 and 11, the dental framework 24 is additive manufactured on a base plate (or support plate) 40 and is at least partially spaced-apart therefrom and is supported by support structures 42.

Then, the support plate 40 including the dental framework 24 mounted thereto is inserted in an injection mold 245 as shown in FIG. 12 and the denture mucosal tissue material (or denture gum-material), for instance acrylic resin, or any other suitable dental prosthesis material to replicate the patient's gum, is injected inside the injection mold 50. The denture mucosal tissue material fills an injection mold chamber 55 including the void of the 3D lattice network 34, i.e., the free space between the strips, to obtain a denture mucosal tissue material block (or denture gum-material based block) 44 supported by the base plate 40. The dental framework 24 is entirely embedded (or contained) in the denture mucosal tissue material block 44. Since the dental framework printing is carried out using the same base plate 40 as the injection molding process, the exact position of the dental framework 24 inside the denture mucosal tissue material block 44 is known.

Once set, the denture mucosal tissue material block and the base plate assembly is removed 255 from the injection mold chamber 55 and is transferred to a machining unit wherein the denture mucosal tissue material block is separated from the base plate and then, is machined 260. In a non-limitative embodiment, the denture mucosal tissue material block 44 is machined in a 5 axis-milling center to define the shape of the denture gum-material body 22, to expose the dental framework 24, if desired, and the support posts 36. In a non-limitative embodiment, the denture mucosal tissue material block 44 is machined in a single machining step.

Then, the denture teeth are bonded with a suitable adhesive, such as and without being limitative ceramic glue, to the machined denture gum-material body, including the dental framework 24, in the desired configuration/position/orientation 265 and, a final polishing step can be performed to finalize the dental prosthesis 20.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements. It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

It will be appreciated that the methods described herein may be performed in the described order, or in any suitable order.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A dental prosthesis comprising:
a prosthesis body with a mucosal tissue-contacting surface and an outer surface, the prosthesis body comprising:
a dental framework comprising a base and a 3D lattice network protruding from the base; and
a denture mucosal tissue body mounted to the dental framework and filing void of the 3D lattice network.

2. The dental prosthesis of claim 1, wherein the dental prosthesis further comprises denture teeth mounted to the prosthesis body and having an exposed portion protruding from the outer surface of the prosthesis body.

3. The dental prosthesis of claim 1, wherein the dental framework further comprises support posts engageable with anchors protruding from a mucosal tissue of a patient's jaw, each one of the support posts comprises an anchor connector extending from the base of the dental framework and on a side opposed to the 3D lattice network, wherein the anchor connector comprises a tubular body substantially circular in cross-section.

4-7. (canceled)

8. The dental prosthesis of claim 1, wherein the dental framework is made of a material selected from the group consisting of titanium, cobalt, chrome, zirconia, silver, palladium, nickel, and plastic and is made by additive manufacturing.

9-10. (canceled)

11. The dental prosthesis of claim 1, wherein the 3D lattice network comprises a crisscross pattern of strips wherein at least 80% of volume is void, and wherein a diameter of the strips of the 3D lattice network is ranging between 0.1 mm and 0.3 mm.

12-14. (canceled)

15. The dental prosthesis of claim 1, wherein the 3D lattice network is integral with the base and is entirely contained in the denture mucosal tissue body.

16. (canceled)

17. The dental prosthesis of claim 1, wherein a layer of the denture mucosal tissue body covers the 3D lattice network and the layer has a thickness sufficient to receive a portion of denture teeth therein.

18-19. (canceled)

20. The dental prosthesis of claim 1, wherein a surface of the base from which the 3D lattice network protrudes is concave, and wherein the 3D lattice network extends outwardly of a U-shaped cavity defined by the concave surface of the base.

21-40. (canceled)

41. A process for manufacturing a dental prosthesis comprising:
manufacturing a dental framework by additive manufacturing, the dental framework comprising a base and a 3D lattice network protruding from the base;
inserting the dental framework in an injection mold;
injecting a denture mucosal tissue material in the injection mold to embed the 3D lattice network of the dental framework at least partially in the denture mucosal tissue material; and
machining an assembly including the dental framework at least partially covered by the denture mucosal tissue material to obtain the dental prosthesis including the dental framework at least partially embedded in a denture mucosal tissue body.

42. The process of claim 41, further comprising generating a 3D digital model of the dental prosthesis including a 3D digital model of a dental framework of the dental prosthesis and denture teeth positions, and wherein the manufacturing of the dental framework and the machining of the assembly are carried out using the 3D digital model.

43-44. (canceled)

45. The process of claim 42, further comprising generating a 3D digital model of a patient's jaw including soft tissue contours and anchor positions and designing the 3D digital model of the dental framework using the 3D digital model of the patient's jaw, and wherein machining the denture mucosal tissue material comprises shaping an impression surface of the dental prosthesis to have at least a portion thereof being complementary in shape to the soft tissue contours of the patient's jaw.

46. (canceled)

47. The process of claim 41, wherein the dental framework further comprises support posts and machining the assembly comprises machining the denture mucosal tissue material to expose at least partially the support posts on an impression surface of the dental prosthesis.

48. The process of claim 41, wherein the dental framework is manufactured by additive manufacturing on a support plate.

49-50. (canceled)

51. The process of claim 41, wherein injecting the denture mucosal tissue material in the injection mold forms a denture mucosal tissue material block in which the dental framework is embedded.

52-53. (canceled)

54. A process for manufacturing a dental prosthesis comprising:
manufacturing a dental framework by additive manufacturing on a support plate;
inserting the dental framework mounted to the support plate in an injection mold;
injecting a denture mucosal tissue material in the injection mold to embed the dental framework at least partially in the denture mucosal tissue material and form a denture mucosal tissue material block including the dental framework mounted to the support plate; and
machining the denture mucosal tissue material block to obtain the dental prosthesis including the dental framework at least partially embedded in a denture mucosal tissue body.

55. The process of claim 54, wherein the dental framework comprises a base and a 3D lattice network protruding from the base.

56. (canceled)

57. The process of claim 54, further comprising generating a 3D digital model of the dental prosthesis including a 3D digital model of a dental framework of the dental prosthesis and denture teeth positions, and wherein the manufacturing of the dental framework and the machining the denture mucosal tissue material block are carried out using the 3D digital model.

58-59. (canceled)

60. The process of claim 57, further comprising generating a 3D digital model of a patient's jaw including soft tissue contours and anchor positions and designing the 3D digital model of the dental framework using the 3D digital model of the patient's jaw, and wherein machining the denture mucosal tissue material comprises shaping an impression surface of the dental prosthesis to have at least a portion thereof being complementary is shape to the soft tissue contours of the patient's jaw.

61-62. (canceled)

63. The process of claim 54, wherein machining the denture mucosal tissue material block comprises separating the dental framework from the support plate.

64. (canceled)

65. The process of claim 54, further comprising mounting denture teeth to the denture mucosal tissue body of the dental prosthesis.

66-76. (canceled)
